(19) United States
(12) Patent Application Publication
(10) Pub. No.: US 2024/0428078 A1
(43) Pub. Date: Dec. 26, 2024

(54) Using Unsupervised Learning For User Specific Anomaly Detection

(71) Applicant: Bank of America Corporation, Charlotte, NC (US)

(72) Inventors: Vijaya L. Vemireddy, Plano, TX (US); Marcus Matos, Richardson, TX (US); Daniel Joseph Serna, The Colony, TX (US); Kevin Delson, Woodland Hills, CA (US)

(73) Assignee: Bank of America Corporation, Charlotte, NC (US)

(21) Appl. No.: 18/211,804

(22) Filed: Jun. 20, 2023

(51) Int. Cl. G06N 3/088

(52) U.S. Cl. CPC G06N 3/088

(57) ABSTRACT

A computing platform may train, using unsupervised learning techniques, a synthetic identity detection model to detect attempts to generate synthetic identities. The computing platform may receive identity information corresponding to an identity generation request. The computing platform may use the synthetic identity detection model to: 1) generate information clusters corresponding to the identity information, 2) compare a difference between actual and expected information clusters to an anomaly detection threshold, 3) based on identifying that the number of information clusters meets or exceeds the anomaly detection threshold, generate a threat score corresponding to the identity information, 4) compare the threat score to a synthetic identity detection threshold, and 5) based on identifying that the threat score meets or exceeds the synthetic identity detection threshold, identify a synthetic identity generation attempt. The computing platform may prevent generation of the synthetic identity and may send a notification indicating the synthetic identity generation attempt.

### BACKGROUND

In some instances, malicious actors may attempt to create a synthetic identity using information corresponding to one or more valid users. In some instances, a model may be trained to understand information associated with given users, and to detect synthetic identity generation attempts based on deviations in such information. In these instances, however, the models may be only as effective and/or sophisticated as the assumptions/techniques used to construct the models. Accordingly, there may be limitations on how effective such models are in identifying synthetic identity generation attempts, which may result in a number of undetected attempts. It may thus be important to improve the quality of synthetic identity detection models to improve their detection capabilities.

### SUMMARY

Aspects of the disclosure provide effective, efficient, scalable, and convenient technical solutions that address and overcome the technical problems associated with synthetic identity detection. In accordance with one or more embodiments of the disclosure, a computing platform comprising at least one processor, a communication interface, and memory storing computer-readable instructions may train, using unsupervised learning techniques, a synthetic identity detection model, which may configure the synthetic identity detection model to detect attempts to generate synthetic identities. The computing platform may receive identity information corresponding to an identity generation request. The computing platform may input, into the synthetic identity detection model, the identity information, which may cause the synthetic identity detection model to: 1) generate information clusters corresponding to the identity information, 2) identify a difference between a number of the information clusters and an anticipated number of information clusters, 3) compare of the difference in information clusters to an anomaly detection threshold, 4) based on identifying that the difference in information clusters meets or exceeds the anomaly detection threshold, generate a threat score corresponding to the identity information, 5) compare the threat score to a synthetic identity detection threshold, and 6) based on identifying that the threat score meets or exceeds the synthetic identity detection threshold, identify a synthetic identity generation attempt. The computing platform may prevent the requested identity generation. The computing platform may send, to an administrator computing device, a notification indicating the synthetic identity generation attempt.

In one or more instances, the synthetic identity detection model may be a Density-Based Spatial Clustering of Applications with Noise (DBSCAN) model. In one or more instances, each information cluster may have an information node, and each information node may represent a particular piece of the identity information.

In one or more examples, the anomaly detection threshold may be automatically identified based on profile information of a valid user corresponding to the synthetic identity. In one or more examples, the anomaly detection threshold may be configurable by a valid user corresponding to the synthetic identity.

In one or more instances, the computing platform may receive, from the valid user, a request for a financial product. The computing platform may identify whether or not to grant the request for the financial product, where the identification of whether or not to grant the request for the financial product may be based on the anomaly detection threshold.

In one or more examples, the anomaly detection threshold may correspond to a percentage change in the number of the information clusters over time. In one or more examples, based on identifying that the difference in information clusters does not meet or exceed the anomaly detection threshold, the computing platform may generate an identity corresponding to the identity generation request.

In one or more instances, generating the threat score may include identifying a likelihood that the identity generation request is valid based on known identity information of a valid user corresponding to the identity generation request. In one or more instances, generating the threat score may include prompting for additional identity information, and generating the threat score may be further based on the additional identity information.

In one or more examples, the additional identity information may include an amount of time elapsed between prompting for the additional identity information and receiving the additional identity information. In one or more examples, generating the threat score may include identifying a data collision between the identity information and known identity information, corresponding to a user other than a valid user corresponding to the identity generation request, and where the known identity information may include one or more of: internally stored information or third party information.

In one or more instances, identifying the data collision may include identifying that a phone number included in the identity information corresponds to the user other than the valid user. In one or more instances, based on identifying that the threat score does not meet or exceed the synthetic identity detection threshold, the computing platform may generate an identity corresponding to the identity generation request. In one or more instances, the computing platform may update, using a dynamic feedback loop and based on the number of information clusters, the threat score, and the identity information, the synthetic identity detection model.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using unsupervised learning to detect synthetic identity generation attempts in accordance with one or more example embodiments.

FIGS. 2A-2C depict an illustrative event sequence for using unsupervised learning to detect synthetic identity generation attempts in accordance with one or more example embodiments.

FIG. 3 depicts an illustrative method for using unsupervised learning to detect synthetic identity generation attempts in accordance with one or more example embodiments.

FIGS. 4-5 depict illustrative user interfaces for using unsupervised learning to detect synthetic identity generation attempts in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using data clustering for anomaly detection to prevent the generation of synthetic identities, as is described further below. In some instances, historical data may be used to detect anomalies as new data is introduced. Unsupervised learning may be used to detect user specific anomalies. For example, an unsupervised learning model may be built from historical data from various users (e.g., social security number, income, account information, or the like). Execution of the model on historical data may generate a number of clusters of data. As new data for a user is introduced, the model may be executed and the number of data clusters output may be compared to an expected number based on execution using the historical data. If the number of data clusters does not match the expected number (or is not within a threshold number/percentage), the user may be flagged for investigation. While supervised learning may be used, unsupervised learning may be particularly advantageous because it does not rely on user identification of relevant data points. All data may be clustered and the number of clusters, rather than a particular type of data, may be used to detect an anomaly or potentially fraudulent activity.

Based on historical identity profile information, an unsupervised learning model (such as Density-Based Spatial Clustering of Applications with Noise (DBSCAN)) may be built to identify an expected cluster set. For example, based on historical information, four clusters may be expected for a user. As potentially fraudulent identity information comes into the model, additional clusters may be identified. The fact that such new clusters are identified may be used to trigger additional review and investigation (e.g., “why do we now have a fifth or sixth cluster?”). These and other features are described in greater details below.

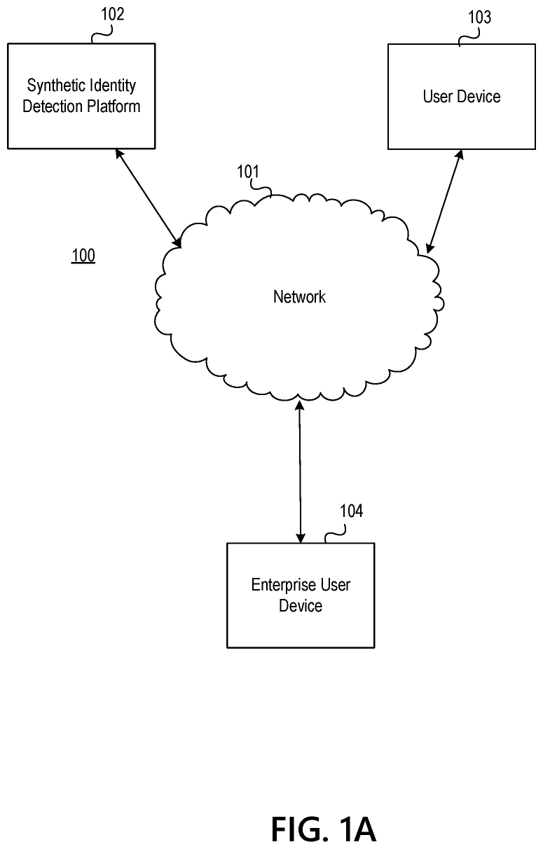

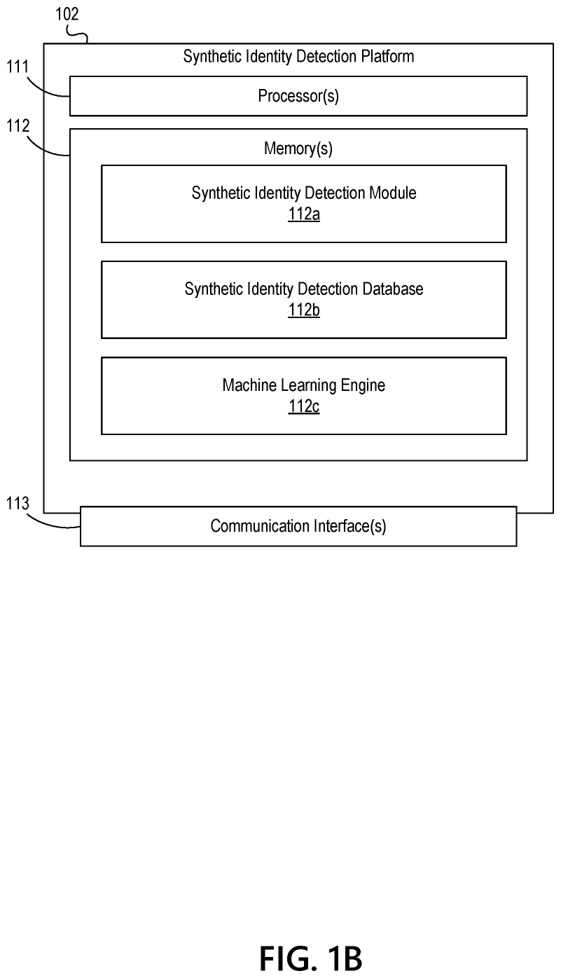

FIGS. 1A-1B depict an illustrative computing environment for using unsupervised learning to detect synthetic identity generation attempts in accordance with one or more example embodiments. Referring to FIG. 1A, computing environment 100 may include one or more computer systems. For example, computing environment 100 may include a synthetic identity detection platform 102, a user device 103, and an enterprise user device 104.

Synthetic identity detection platform 102 may include one or more computing devices and/or other computer components (e.g., processors, memories, communication interfaces, or the like). For example, the synthetic identity detection platform 102 may be configured to generate, update, and/or otherwise maintain an unsupervised learning model (such as Density-Based Spatial Clustering of Applications with Noise (DBSCAN), or other unsupervised learning model). In some instances, the unsupervised learning model may be trained to identify cluster anomalies, which may, in some instances, be indicative of fraudulent activity. Based on identifying a synthetic identity generation attempt, the synthetic identity detection platform 102 may trigger one or more security actions (e.g., sending alerts and/or performing other actions).

User device 103 may be or include one or more devices (e.g., laptop computers, desktop computer, smartphones, tablets, and/or other devices) configured for use in providing identity information for identity generation (e.g., account generation, profile generation, or the like). In some instances, this may correspond to a legitimate identity generation (e.g., by a valid user) or a synthetic identity generation (e.g., a fraudulent attempt to misuse or misappropriate an identity and/or pieces of personal identifiable information of a valid user). In some instances, the user device 103 may be configured to display graphical user interfaces (e.g., information entry interfaces, identity generation interfaces, or the like). Any number of such user devices may be used to implement the techniques described herein without departing from the scope of the disclosure.

Enterprise user device 104 may be or include one or more devices (e.g., laptop computers, desktop computer, smartphones, tablets, and/or other devices) configured for use in providing identity protection services. For example, the enterprise user device 104 may be used by an employee of an organization (e.g., such as an organization corresponding to the synthetic identity detection platform 102). In some instances, the enterprise user device 104 may be configured to display graphical user interfaces (e.g., synthetic identity detection interfaces, or the like). Any number of such user devices may be used to implement the techniques described herein without departing from the scope of the disclosure.

Computing environment 100 also may include one or more networks, which may interconnect synthetic identity detection platform 102, user device 103, and enterprise user device 104. For example, computing environment 100 may include a network 101 (which may interconnect, e.g., synthetic identity detection platform 102, user device 103, and enterprise user device 104).

In one or more arrangements, synthetic identity detection platform 102, user device 103, and enterprise user device 104 may be any type of computing device capable of receiving a user interface, receiving input via the user interface, and communicating the received input to one or more other computing devices. For example, synthetic identity detection platform 102, user device 103, enterprise user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of synthetic identity detection platform 102, user device 103, and enterprise user device 104 may, in some instances, be special-purpose computing devices configured to perform specific functions.

Referring to FIG. 1B, synthetic identity detection platform 102 may include one or more processors 111, memory 112, and communication interface 113. A data bus may interconnect processor 111, memory 112, and communication interface 113. Communication interface 113 may be a network interface configured to support communication between synthetic identity detection platform 102 and one or more networks (e.g., network 101, or the like). Memory 112 may include one or more program modules having instructions that when executed by processor 111 cause synthetic identity detection platform 102 to perform one or more functions described herein and/or one or more databases that may store and/or otherwise maintain information which may be used by such program modules and/or processor 111. In some instances, the one or more program modules and/or databases may be stored by and/or maintained in different memory units of synthetic identity detection platform 102 and/or by different computing devices that may form and/or otherwise make up synthetic identity detection platform 102. For example, memory 112 may have, host, store, and/or include synthetic identity detection module 112a, synthetic identity detection database 112b, and machine learning engine 112c. Synthetic identity detection module 112a may have instructions that direct and/or cause synthetic identity detection platform 102 to execute advanced optimization techniques to generate, apply, and/or otherwise maintain an unsupervised learning model for synthetic identity detection. Synthetic identity detection database 112b may store information used by synthetic identity detection module 112a, in executing, generating, applying, and/or otherwise maintaining an unsupervised learning model for synthetic identity detection and/or in performing other functions. Machine learning engine 112c may be used to train, deploy, and/or otherwise refine models used to support functionality of the synthetic identity detection module 112a through both initial training and one or more dynamic feedback loops, which may, e.g., enable continuous improvement of the synthetic identity detection platform 102 and further optimize the identification and prevention of attempts to generate synthetic identities.

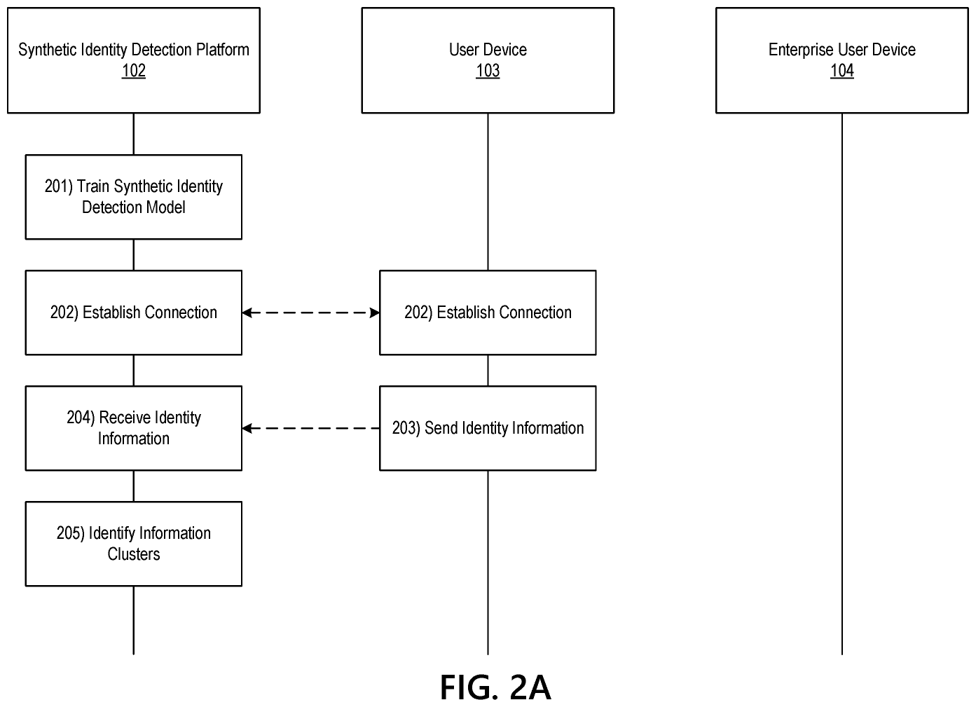

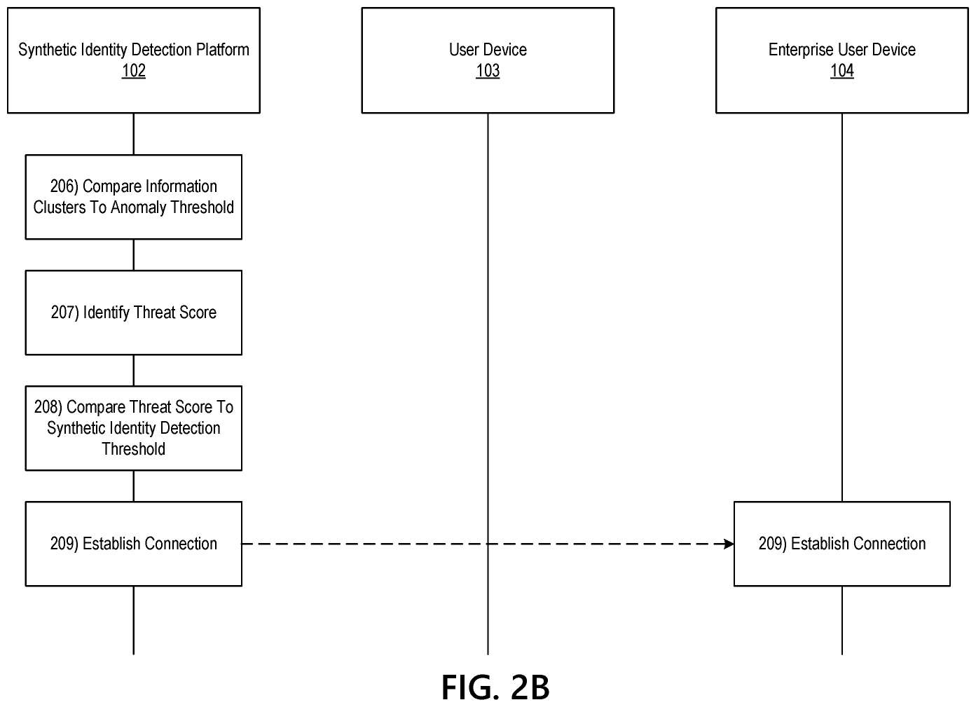

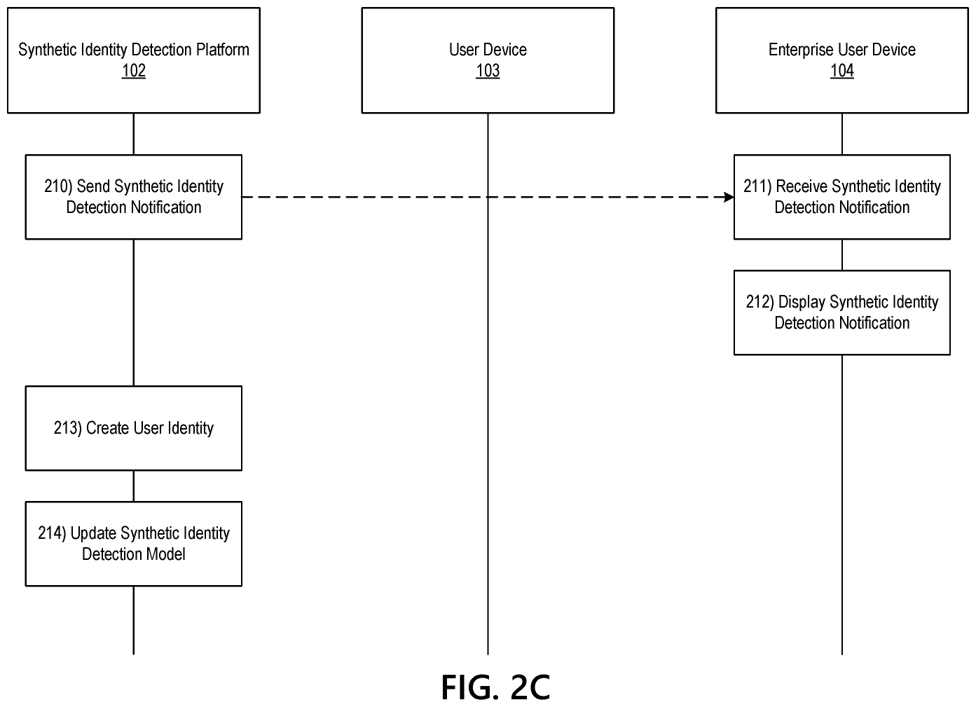

FIGS. 2A-2C depict an illustrative event sequence for using unsupervised learning to detect synthetic identity generation attempts in accordance with one or more example embodiments. Referring to FIG. 2A, at step 201, the synthetic identity detection platform 102 may train a synthetic identity detection model. For example, the synthetic identity detection platform 102 may receive historical user identity information (e.g., social security number, income, account information, demographic information, address information, employment information, contact information, and/or other information that may correspond to an identity of a given user).

In some instances, the synthetic identity detection model may be trained using one or more unsupervised learning techniques to generate information clusters for various individuals based on the historical user identity information. In some instances, this historical user identity information may be procured from internal data sources (e.g., an internal client database, or the like) and/or external data sources (e.g., social media accounts, public records, or the like). In some instances, the synthetic identity detection platform 102 may train the synthetic identity detection model using one or more unsupervised learning techniques (e.g., classification, regression, clustering, anomaly detection, artificial neutral networks, and/or other supervised models/techniques). In some instances, the synthetic identity detection platform 102 may train a Density-Based Spatial Clustering of Applications with Noise (DBSCAN) and/or other unsupervised learning model. Accordingly, the synthetic identity detection model may ultimately be trained to cluster identity information on a user by user basis, and compare a number of clusters created responsive to an identity creation request (e.g., a request to open an account, generate a profile, or the like) to an anticipated number of clusters for a corresponding valid user (e.g., based on the clusters generated based on the historical user identity information). In these instances, the synthetic identity detection model may identify whether or not a number of newly generated clusters exceeds an anomaly threshold based on the anticipated number of clusters, and if so, may identify a potential synthetic identity generation request (if not, the synthetic identity detection model may identify a valid identity generation request).

In some instances, the synthetic identity detection platform 102 may further train the synthetic identity detection model to identity threat scores based on identity information. For example, the synthetic identity detection model may be trained to identify correlations between identity information and a likelihood of a synthetic identity (e.g., by correlating previous identifications of a synthetic identity with the corresponding identity information).

At step 202, the user device 103 may establish a connection with the synthetic identity detection platform 102. For example, the user device 103 may establish a first wireless data connection with the synthetic identity detection platform 102 to link the user device 103 to the synthetic identity detection platform 102 (e.g., in preparation for sending identity information, identity generation requests, or the like). In some instances, the user device 103 may identify whether or not a connection is already established with the synthetic identity detection platform 102. If a connection is already established with the synthetic identity detection platform 102, the user device 103 might not re-establish the connection. If a connection is not yet established with the synthetic identity detection platform 102, the user device 103 may establish the first wireless data connection as described herein.

At step 203, the user device 103 may send identity information and/or an identity generation request (e.g., request to create a profile, account, or the like). For example, the user device 103 may send social security numbers, income, account information, transaction information, demographic information, address information, employment information, contact information, social media information, and/or other information that may correspond to an identity of a given user. In some instances, the identity information may all correspond to a valid user who may be operating the user device 103. In other instances, the identity information may correspond to one or more valid users, but these valid users may be different than a bad actor who may be operating the user device 103 (e.g., attempting to impersonate the one or more valid users). In some instances, the user device 103 may send the identity information to the synthetic identity detection platform 102 while the first wireless data connection is established.

At step 204, the synthetic identity detection platform 102 may receive the identity information (sent at step 203) from the user device 103. For example, the synthetic identity detection platform 102 may receive the identity information via the communication interface 113 and while the first wireless data connection is established.

At step 205, the synthetic identity detection platform 102 may identify a number of information clusters corresponding to the identity information received at step 204. For example, using similar clustering techniques as those described above with regard to step 201, the synthetic identity detection model may identify a number of clusters corresponding to the identity information.

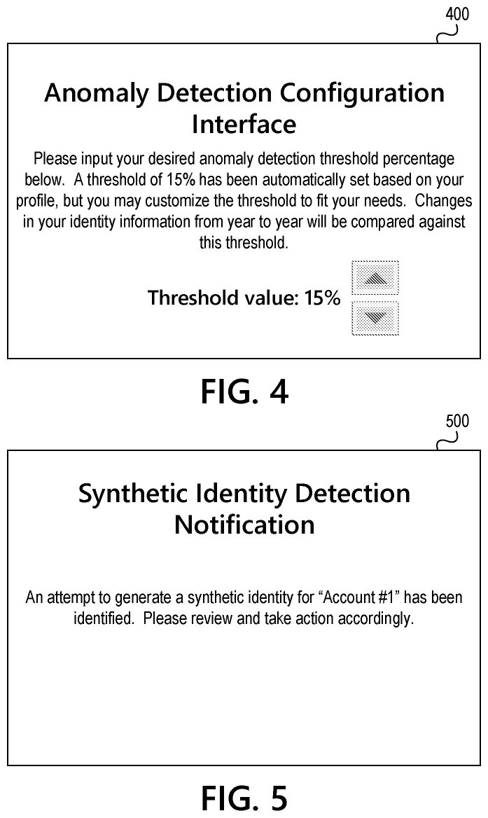

Referring to FIG. 2B, at step 206, the synthetic identity detection platform 102 may use the synthetic identity detection model to identify a difference between the number of clusters identified at step 205 and a number of anticipated clusters corresponding to a valid user associated with the identity information. For example, if a user is attempting to generate a synthetic identity with information that does not correspond to a valid user of the identity, a number of clusters created may be different than an anticipated number of clusters (e.g., because nodes corresponding to this inaccurate information may be created). For example, the synthetic identity detection platform 102 may identify that the identity information corresponds to fifteen clusters, whereas a valid identity corresponding to the information corresponds to ten clusters. In some instances, each cluster may include at least one information node corresponding to a particular piece of identity information. The synthetic identity detection model may then compare the difference to an anomaly threshold corresponding to the valid user. In some instances, the anomaly threshold may be automatically identified by the synthetic identity detection model (e.g., based on information associated with the valid user such as life stages (e.g., contributions to a college fund may be expected at certain stages rather than others, certain changes in information may be expected due to a change in marital status (e.g., new account, new address, new job, or the like), or the like), similarly situated users (e.g., based on preexisting conditions, demographic information, information provided by a user who has opted in to provide additional information (e.g., health information, changes in spending behavior, natural disaster information, or the like), social media information (e.g., newer profiles and/or less friends may be more indicative of a fraudulent profile than more established/older profiles with more friends), and/or otherwise) and/or manually selected by the corresponding user. For example, a user may toggle their anomaly threshold based on their particular risk appetite (e.g., using a graphical user interface similar to graphical user interface 400, which is illustrated in FIG. 4). In some instances, the user may set a threshold differential in clusters/nodes, a percentage change (e.g., year over year, or the like), or the like. For example, with regard to the percentage change, the threshold may correspond to an acceptable variation in clusters from year to year. Accordingly, the higher the threshold, the more risk tolerant a user may be. In some instances, this risk tolerance may be used to inform alternative decisions made on behalf of an enterprise (e.g., corresponding to the synthetic identity detection platform 102) such as decisions to grant loans, lines of credit, interest rates, and/or other financial products. For example, a higher rate may be assigned for an individual with a higher tolerance for risk, as this may present a larger risk to the enterprise. Similarly, the enterprise may generally view individuals with higher thresholds as more risky and individuals with lower thresholds as less risky. In some instances, a user may set the anomaly threshold through selection of a user interface element (as reflected in FIG. 4), which may, in some instances, cause the threshold to be modified, cause backend information associated with the user to be modified (which may, e.g., trigger effects on downstream enterprise decisions), cause an interface to be rearranged (e.g., update the displayed threshold percentage), and/or cause the performance of other actions.

If the synthetic identity detection model identifies that the difference meets or exceeds the anomaly detection threshold, the synthetic identity detection platform 102 may proceed to step 207. If the synthetic identity detection model identifies that the difference does not meet or exceed the anomaly detection threshold, the synthetic identity detection platform 102 may proceed to step 213.

At step 207, the synthetic identity detection model may identify a threat score corresponding to the identity information. For example, the synthetic identity detection model analyze the identity information to identify a likelihood that it corresponds to a fraudulent request. In some instances, the synthetic identity detection model may analyze data collisions (e.g., does an address, phone number, or the like included in the identity information correspond to a different customer or individual based on internally stored information, third party information, or the like). If a collision is detected, the synthetic identity detection model may factor this into the threat score. Additionally or alternatively, the synthetic identity detection model may analyze whether or not an area code of a provided phone number matches that of an address associated with the user, and may factor this decision into the threat score. Additionally or alternatively, the synthetic identity detection model may analyze the identified cluster discrepancies to identify whether or not a valid reason exists for the discrepancy. For example, the synthetic identity detection model may identify whether or not the user moved (and thus has additional clusters based on the move), changed jobs (and thus has additional clusters based on the new job), or the like. These are examples only and other analysis may be performed by the synthetic identity detection model to essentially provide a second layer of analysis, beyond the cluster comparison, regarding whether or not the identity information corresponds to a fraudulent request. In these instances, the higher the threat score is, the more confident the synthetic identity detection model may be that the identity information corresponds to a fraudulent request.

In some instances, identifying the threat score may include prompting a user of the user device 103 for additional information. For example, the synthetic identity detection platform 102 may cause the user device 103 to prompt the user to input additional information (e.g., verbally, using a display of the user device 103, and/or otherwise), and may then analyze information corresponding to the input of the additional information (e.g., how long did it take, pauses in the user's speech, other speech patterns, how in depth a response is, or the like). These may, for example, allow the synthetic identity detection platform 102 to distinguish between valid users and fraudulent impersonators/bots. In these instances, the synthetic identity detection model may have been further trained on associations between such characteristics and a likelihood of a fraudulent request.

At step 208, the synthetic identity detection platform 102 may compare the threat score (identified at step 207) to a synthetic identity detection threshold. Based on identifying that the threat score meets or exceeds the synthetic identity detection threshold, the synthetic identity detection platform 102 may identify that the identity information may correspond to a synthetic identity generation request, and may proceed to step 209. Otherwise, based on identifying that the threat score does not meet or exceed the synthetic identity detection threshold, the synthetic identity detection platform 102 may identify that the identity information corresponds to a legitimate identity generation request, and may proceed to step 213.

At step 209, the synthetic identity detection platform 102 may establish a connection with the enterprise user device 104. For example, the synthetic identity detection platform 102 may establish a second wireless data connection with the enterprise user device 104 to link the synthetic identity detection platform 102 with the enterprise user device 104 (e.g., in preparation for sending synthetic identity detection notifications). In some instances, the synthetic identity detection platform 102 may identify whether or not a connection is already established with the enterprise user device 104. If the synthetic identity detection platform 102 identifies that a connection is already established, the synthetic identity detection platform 102 might not re-establish the connection. If the synthetic identity detection platform 102 identifies that the connection is not yet established, the synthetic identity detection platform 102 may establish the second wireless data connection as described herein.

Referring to FIG. 2C, at step 210, the synthetic identity detection platform 102 may send a synthetic identity detection notification to the enterprise user device 104. For example, the synthetic identity detection platform 102 may send a synthetic identity detection notification to the enterprise user device 104 via the communication interface 113 and while the second wireless data connection is established. In some instances, the synthetic identity detection platform 102 may also send one or more commands directing the enterprise user device 104 to display the synthetic identity detection notification.

At step 211, the enterprise user device 104 may receive the synthetic identity detection notification sent at step 210. For example, the enterprise user device 104 may receive the synthetic identity detection notification while the second wireless data connection is established. In some instances, the enterprise user device 104 may also receive one or more commands directing the enterprise user device 104 to display the synthetic identity detection notification.

At step 212, based on or in response to the one or more commands directing the enterprise user device 104 to display the synthetic identity detection notification, the enterprise user device 104 may display the synthetic identity detection notification. For example, the enterprise user device 104 may display a graphical user interface similar to graphical user interface 500, which is illustrated in FIG. 5. The synthetic identity detection platform 102 may then proceed to step 214 without creating the user identity as described below at step 213.

In some instances, in addition or as an alternative to generating the synthetic identity detection notification as described above at steps 210-212, the synthetic identity detection platform 102 may trigger the performance of one or more automated security actions (e.g., putting a temporary hold on a user account, preventing generation of a requested synthetic identity, blocking login attempts and prompting for additional authentication mechanisms, and/or performing other actions).

Returning to steps 206 and/or 208, if the synthetic identity detection platform 102 identifies that the difference in the number of clusters does not meet or exceed the anomaly threshold and/or that the threat score does not meet or exceed the synthetic identity detection threshold, the synthetic identity detection platform 102 may have identified that the identity information corresponds to a valid identity generation request, and may have proceeded to step 213. In further reference to FIG. 2C, at step 213, the synthetic identity detection platform 102 may generate a user identity (e.g., account, profile, or the like) based on the identity information.

At step 214, the synthetic identity detection platform 102 may update the synthetic identity detection model based on the identity information, the threat score, the identification of whether or not the identity information corresponds to a synthetic identity generation request, and/or other information. In doing so, the synthetic identity detection platform 102 may continue to refine the synthetic identity detection model using a dynamic feedback loop, which may, e.g., increase the accuracy and effectiveness of the model in identifying synthetic identity generation requests. For example, the synthetic identity detection platform 102 may reinforce, modify, and/or otherwise update the synthetic identity detection model, thus causing the model to continuously improve (e.g., in terms of identifying synthetic identity detection models).

In some instances, the synthetic identity detection platform 102 may continuously refine the synthetic identity detection model. In some instances, the synthetic identity detection platform 102 may maintain an accuracy threshold for the synthetic identity detection model, and may pause refinement (through the dynamic feedback loops) of the model if the corresponding accuracy is identified as greater than the corresponding accuracy threshold. Similarly, if the accuracy fails to be equal or less than the given accuracy threshold, the synthetic identity detection platform 102 may resume refinement of the model through the corresponding dynamic feedback loop.

By operating in this way, the synthetic identity detection platform 102 may identify attempts to generate synthetic identities without relying on assumptions or decisions made in training a supervised learning model. Rather, by using an unsupervised model, the synthetic identity detection platform 102 may let the data speak for itself, thus avoiding any preconceived hypotheses, assumptions, decisions, and/or other information used to inform the model training. This may result in a model with an increased effectiveness in identifying synthetic identity generation attempts when compared with supervised learning models.

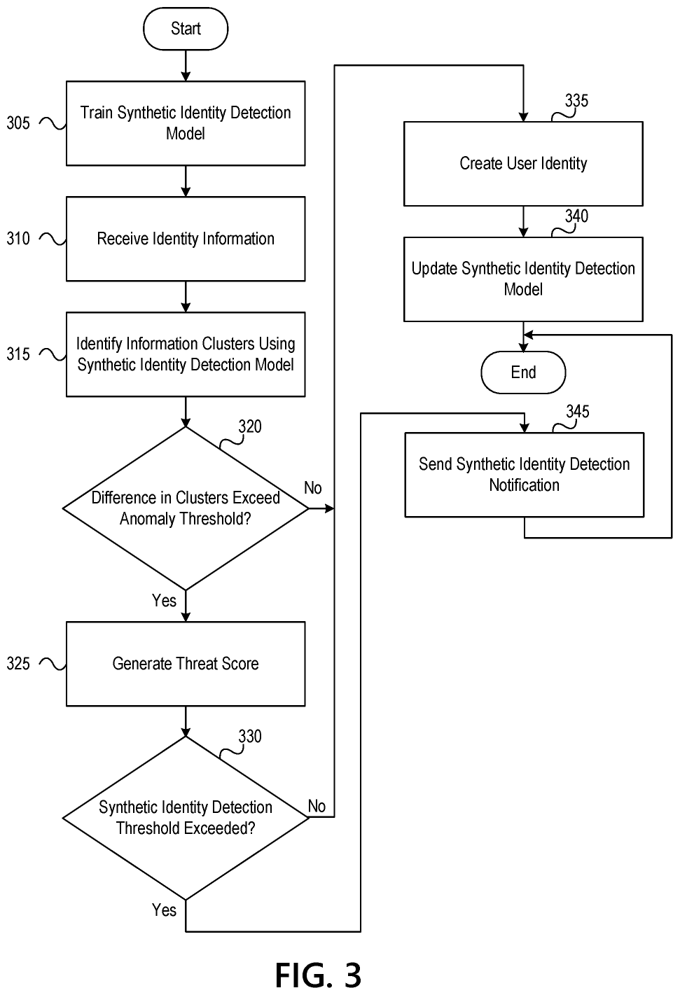

FIG. 3 depicts an illustrative method for using unsupervised learning to detect synthetic identity generation attempts in accordance with one or more example embodiments. Referring to FIG. 3, at step 305, a computing platform comprising one or more processors, memory, and a communication interface may train a synthetic identity detection model. At step 310, the computing platform may receive identity information. At step 315, the computing platform may identify information clusters using the synthetic identity detection model. At step 320, the computing platform may identify whether or not a difference between the number of clusters identified and an anticipated number of clusters exceeds an anomaly threshold. If the difference does not exceed the anomaly threshold, the computing platform may proceed to step 335. If the difference does exceed the anomaly threshold, the computing platform may proceed to step 325.

At step 325, the computing platform may generate a threat score for the identity information. At step 330, the computing platform may identify whether or not the synthetic identity detection threshold is met or exceeded. If the synthetic identity detection threshold is not met or exceeded, the computing platform may proceed to step 335. If the synthetic identity detection threshold is met, the computing platform may proceed to step 345.

At step 335, the computing platform may create a user identity based on the identity information. At step 340, the computing platform may update the synthetic identity detection model.

At step 345, the computing platform may send a synthetic identity detection notification.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using unsupervised learning techniques, a synthetic identity detection model, wherein training the synthetic identity detection model configures the synthetic identity detection model to detect attempts to generate synthetic identities;
receive identity information corresponding to an identity generation request;
input, into the synthetic identity detection model, the identity information, wherein inputting the identity information into the synthetic identity detection model causes the synthetic identity detection model to:
generate information clusters corresponding to the identity information,
identify a difference between a number of the information clusters and an anticipated number of information clusters,
compare the difference in information clusters to an anomaly detection threshold,
based on identifying that the difference in information clusters meets or exceeds the anomaly detection threshold, generate a threat score corresponding to the identity information,
compare the threat score to a synthetic identity detection threshold, and
based on identifying that the threat score meets or exceeds the synthetic identity detection threshold, identify a synthetic identity generation attempt;
prevent the requested identity generation; and
send, to an administrator computing device, a notification indicating the synthetic identity generation attempt.

2. The computing platform of claim 1, wherein the synthetic identity detection model comprises a Density-Based Spatial Clustering of Applications with Noise (DBSCAN) model.

3. The computing platform of claim 1, wherein each information cluster comprises an information node, and wherein each information node represents a particular piece of the identity information.

4. The computing platform of claim 1, wherein the anomaly detection threshold is automatically identified based on profile information of a valid user corresponding to the synthetic identity.

5. The computing platform of claim 1, wherein the anomaly detection threshold is configurable by a valid user corresponding to the synthetic identity.

6. The computing platform of claim 5, wherein the memory stores additional computer readable instructions that, when executed by the at least one processor, cause the computing platform to:
receive, from the valid user, a request for a financial product; and
identify whether or not to grant the request for the financial product, wherein the identification of whether or not to grant the request for the financial product is based on the anomaly detection threshold.

7. The computing platform of claim 1, wherein the anomaly detection threshold corresponds to a percentage change in the number of the information clusters over time.

8. The computing platform of claim 1, wherein the memory stores additional computer readable instructions that, when executed by the at least one processor, cause the computing platform to:
based on identifying that the difference in information clusters does not meet or exceed the anomaly detection threshold, generating an identity corresponding to the identity generation request.

9. The computing platform of claim 1, wherein generating the threat score comprises identifying a likelihood that the identity generation request is valid based on known identity information of a valid user corresponding to the identity generation request.

10. The computing platform of claim 9, wherein generating the threat score comprises prompting for additional identity information, and wherein generating the threat score is further based on the additional identity information.

11. The computing platform of claim 10, wherein the additional identity information includes an amount of time elapsed between prompting for the additional identity information and receiving the additional identity information.

12. The computing platform of claim 1, wherein generating the threat score includes identifying a data collision between the identity information and known identity information, wherein the known identity information corresponds to a user other than a valid user corresponding to the identity generation request, and wherein the known identity information comprises one or more of: internally stored information or third party information.

13. The computing platform of claim 12, wherein identifying the data collision comprises identifying that a phone number included in the identity information corresponds to the user other than the valid user.

14. The computing platform of claim 1, wherein the memory stores additional computer readable instructions that, when executed by the at least one processor, cause the computing platform to:
based on identifying that the threat score does not meet or exceed the synthetic identity detection threshold, generating an identity corresponding to the identity generation request.

15. The computing platform of claim 1, wherein the memory stores additional computer readable instructions that, when executed by the at least one processor, cause the computing platform to:
update, using a dynamic feedback loop and based on the number of information clusters, the threat score, and the identity information, the synthetic identity detection model.

16. A method comprising:
at a computing platform comprising at least one processor, a communication interface, and memory:
training, using unsupervised learning techniques, a synthetic identity detection model, wherein training the synthetic identity detection model configures the synthetic identity detection model to detect attempts to generate synthetic identities;
receiving identity information corresponding to an identity generation request;
inputting, into the synthetic identity detection model, the identity information, wherein inputting the identity information into the synthetic identity detection model causes the synthetic identity detection model to:
generate information clusters corresponding to the identity information,
identify a difference between a number of the information clusters and an anticipated number of information clusters,
compare the difference in information clusters to an anomaly detection threshold,
based on identifying that the difference in information clusters meets or exceeds the anomaly detection threshold, generate a threat score corresponding to the identity information,
compare the threat score to a synthetic identity detection threshold, and
based on identifying that the threat score meets or exceeds the synthetic identity detection threshold, identify a synthetic identity generation attempt;
preventing the requested identity generation; and
sending, to an administrator computing device, a notification indicating the synthetic identity generation attempt.

17. The method of claim 16, wherein the synthetic identity detection model comprises a Density-Based Spatial Clustering of Applications with Noise (DBSCAN) model.

18. The method of claim 16, wherein each information cluster comprises an information node, and wherein each information node represents a particular piece of the identity information.

19. The method of claim 16, wherein the anomaly detection threshold is automatically identified based on profile information of a valid user corresponding to the synthetic identity.

20. One or more non-transitory computer-readable media storing instructions that, when executed by a computing platform comprising at least one processor, a communication interface, and memory, cause the computing platform to:
train, using unsupervised learning techniques, a synthetic identity detection model, wherein training the synthetic identity detection model configures the synthetic identity detection model to detect attempts to generate synthetic identities;
receive identity information corresponding to an identity generation request;
input, into the synthetic identity detection model, the identity information, wherein inputting the identity information into the synthetic identity detection model causes the synthetic identity detection model to:
generate information clusters corresponding to the identity information,
identify a difference between a number of the information clusters and an anticipated number of information clusters,
compare the difference in information clusters to an anomaly detection threshold,
based on identifying that the difference in information clusters meets or exceeds the anomaly detection threshold, generate a threat score corresponding to the identity information,
compare the threat score to a synthetic identity detection threshold, and
based on identifying that the threat score meets or exceeds the synthetic identity detection threshold, identify a synthetic identity generation attempt;
prevent the requested identity generation; and
send, to an administrator computing device, a notification indicating the synthetic identity generation attempt.
